(19) United States
(12) Patent Application Publication
(10) Pub. No.: US 2002/0078166 A1
(43) Pub. Date: Jun. 20, 2002

(54) System and method for integrating a network-based tool

(76) Inventors: Michael A. Motley, Simsbury, CT (US); Kevin Watts, Middletown, CT (US); Dhruva Nagaraj Kadaba, Bangalore, IN (US); John Matthew Spens, Holmes, NY (US)

Correspondence Address: John S. Beulick, Armstrong Teasdale LLP, One Metropolitan Sq., Suite 2600, St. Louis, MO, 63102, US

(21) Appl. No.: 09/739,497

(22) Filed: Dec. 18, 2000

(51) Int. Cl. G06F 15/16

(52) U.S. Cl. 709/217; 709/221

(57) ABSTRACT

A system and method for integrating a network-based tool with a personal computer-based application for selecting and configuring a product. The network based tool, which may be running on a user's PC, saves the data from the configuration to the PC based application. The network-based tool then stores the data in its data storage format, thereby allowing the rest of the PC based application to use the data.

### BACKGROUND OF THE INVENTION

This invention relates generally to use of computer network-based tools, which may be running locally on a user's Personal Computer (PC), and more particularly to a method and system for integrating a web-based tool with a personal computer-based application.

Configuring equipment, particularly sophisticated equipment, can be a daunting task given the array of parameters that typically characterize an item of equipment. This task can be particularly challenging for customers and others who are not familiar with the product. Consequently businesses have created computer-based programs to assist customers in selecting the products they need, and in configuring the products to fit the customer's requirements. For some applications these programs are PC-based.

Such PC-based programs are now being superseded by Internet-based programs that afford customers access to product information that can be continuously and easily updated by the company. Moreover, use of the Internet allows the company to afford users an easy way not only to select and configure the product, but to order the product online. Despite these advantages, companies are often reluctant to force their customers to switch from a familiar PC-based program that the customers are accustomed to using to an unfamiliar, Internet- or other network-based program.

Therefore, it would be desirable to provide a method of integrating a PC-based program with a network-based tool, which may be running locally on a user's PC, to bring the aforementioned advantages of a network-based program to the customer through use of the PC-based program in a way that is transparent to the customer.

### BRIEF SUMMARY OF THE INVENTION

In an exemplary embodiment, a method for integrating a network-based tool, which may be running locally on a user's PC with a personal computer-based (PC-based) application includes a PC-based application that offers a variety of product categories to a user. When the user selects a product category, the PC-based application launches a network-based tool, which may be running locally on a user's PC that leads the user through product selection, configuration, and ordering. The network-based tool receives specification information from the user and compares the received product specification information with pre-stored product information. If at least one product matches the received product specification information, the pre-stored product information is saved to the PC-based program for communication to the user.

The product information may include, for example, features of the product and accessories of the product. The method further includes validating configuration compatibility based on product information data and features of the product to determine whether a resulting product is capable of desired performance for a set of given product parameters.

When a product has been selected, the system then requests information from the user that will allow configuration of the product to meet a user's needs. When the user completes product selection and configuration and indicates a desire to submit the order, the system saves to the PC-based application a copy of the bill of material that has been submitted.

### BRIEF DESCRIPTION OF THE DRAWINGS

FIG. 1 is a system block diagram in accordance with one embodiment of the present invention;

FIG. 2 is an expanded version block diagram of a server architecture of a system in accordance with one embodiment of the present invention;

FIG. 3 is a flow diagram of a method for integrating a network-based tool with a personal computer-based application;

FIG. 4 is an exemplary main screen page of a PC-based application;

FIG. 5 is an exemplary configuration page of a PC-based application;

FIG. 6 is an exemplary configuration page of a network-based tool, which may be running locally on a user's PC;

FIG. 7 is an exemplary information page of a network-based tool; and

FIG. 8 is an exemplary PC-based application page after transfer of data from a network-based tool.

### DETAILED DESCRIPTION OF THE INVENTION

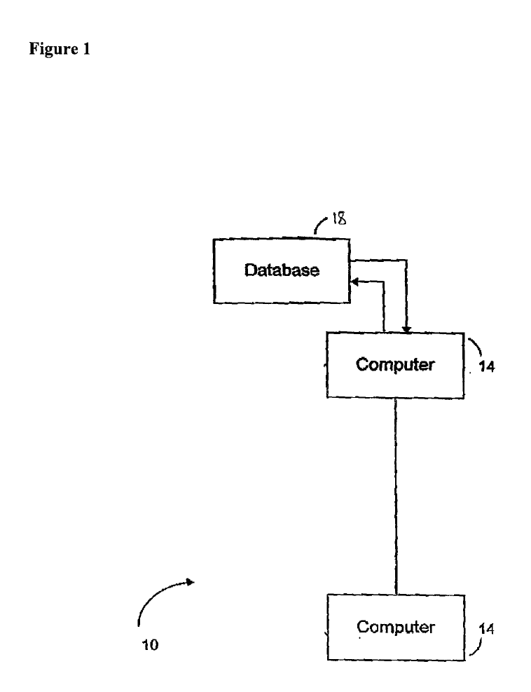

FIG. 1 is a block diagram of a system 10 in accordance with one embodiment of the present invention. System 10 includes a plurality of user devices 14 with at least two connected to each other. In one embodiment, devices 14 are computers including a web browser, and at least two devices 14, a first device 14 and a second device 14, are accessible to each other via a network such as an intranet or the Internet. In an alternative embodiment, devices 14 are servers for a network of devices.

Devices 14 are interconnected to the network, such as a local area network (LAN) or a wide area network (WAN), through many interfaces including dial-in-connections, cable modems and high-speed ISDN lines. Alternatively, devices 14 are any device capable of interconnecting to a network including a network-based phone or other network-based connectable equipment. In one embodiment, centralized database 18 is stored on first device 14.

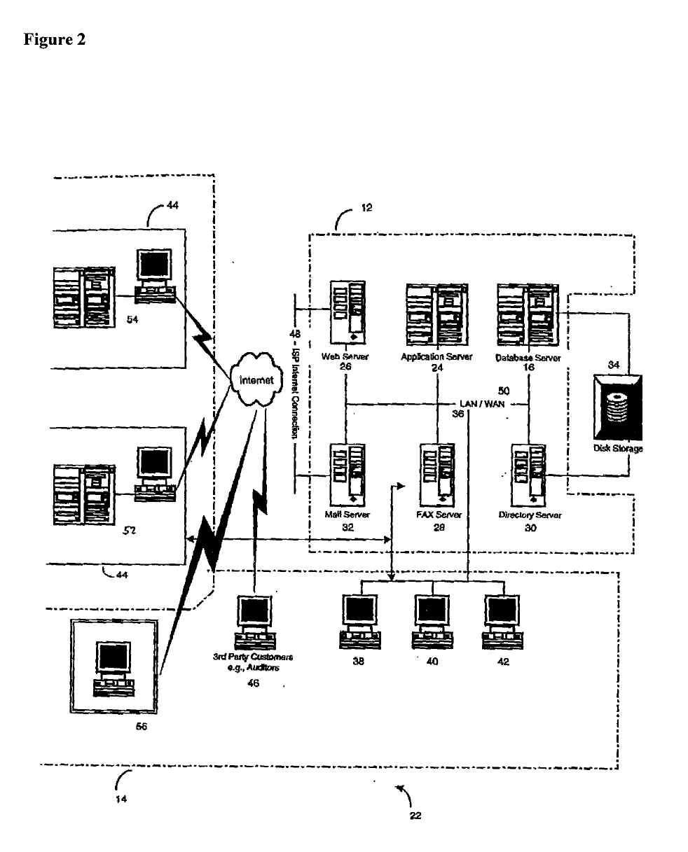

FIG. 2 is an expanded version block diagram of an exemplary embodiment of a server architecture of a system 22. System 22 includes server sub-system 12 and user devices 14. Server sub-system 12 includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a workstation 52 can access server sub-system 12. One of user devices 14 includes a workstation 54 located at a remote location. Workstations 52 and 54 are personal computers having a web browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

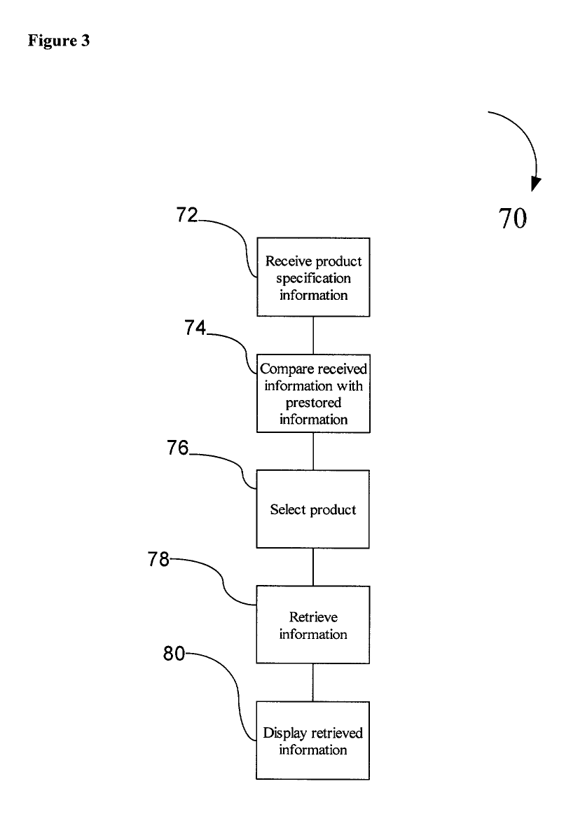

FIG. 3 is a flow diagram 70 for a method for integrating a PC-based application with a network-based tool. In one exemplary embodiment, the product selection includes electrical equipment, and in particular safety switches. In other embodiments, the product selection involves selection of NEMA controls, safety switches, load centers, modular metering, panel boards, switch boards, motor control centers, load interrupter switches, busways, low voltage switchgear, power break switch boards, miscellaneous items, standard drive/drive panels, wall-mounted transient voltage surge suppressors, three-phase pad mounted transformers, liquid-filled transformers, vent dry transformers, cast coil transformers, and neutral grounding resistors. System 10 (shown in FIG. 1) receives 72 product specification information from a user. In one embodiment, the user inputs the information into a device (such as device 14 shown in FIG. 1) that transmits the information to a server (such as server 12 shown in FIG. 1). In another embodiment, the user inputs the information into a device (such as one of the devices 14 shown in FIG. 1) and processes the information on the same device (one of the devices 14). The product specification information is received from the user via a graphical user interface as will be described in greater detail below.

In the exemplary embodiment including selection of safety switches, the received product specification information includes a specification of the switch type, the voltage, the fuse type, the number of polls, the number of wires, the amperage, the type of enclosure.

An application running on one of the devices 14 compares 74 the received safety switch-related requirements to pre-stored information in database 18. The pre-stored information includes various types and configurations of safety switch related information. One of the devices 14 compares the user provided information to the pre-stored information to determine if any pre-stored safety switch information contained in the database satisfy the product specifications/requirements submitted by the user.

In addition, one of the devices 14 assesses the information supplied by the user to validate configuration compatibility of the product. Exemplary information includes product application, product parameters, desired product features, and product accessories. System 10 evaluates the information supplied by the user and determines whether a resulting product incorporating a safety switch having the received product specifications is capable of meeting parameters of the indicated product. For example, system 10 determines whether a selected safety switch with a given requirement is available to satisfy the user, and, if the selected safety switch with a given requirement is not available, system 10 displays a message to the user that the safety switch with the required product characteristics is not available and that the user should select an alternative product. In summary, system 10 reviews the user input and based on a pre-determined safety switch configuration as well as operating specifications, the user is provided feedback for a specific safety switch that meets the criteria for the user application.

If the product resulting from the received information does not meet the parameters of the product, system 10 guides a user by providing suggestions for a correct product configuration. In an alternative embodiment, system 10 guides a user by providing information regarding alternative products compatible with the product parameters supplied by the user. In a further alternative embodiment, system 10 guides a user by providing information regarding products that are upgrades for the product parameters supplied by the user.

System 10 then identifies pre-stored safety switch information that matches the information entered by the user and selects 76 safety switch configurations from the pre-stored information. System 10 retrieves 78 information pertaining to the selected safety switch configuration. In one embodiment, the safety switch information includes a safety switch identifier number and associated price for each selected safety switch configuration. For example, the safety switch identifier number is a catalog number and the price is a list price of the product. One of the devices 14 then transmits the retrieved identifier number and associated price and downloads the retrieved safety switch information to a second device 14 for display 80 so that the user can view the information. In an alternative embodiment, system 10 uses the list price information to generate a quotation for each selected safety switch configuration including the indicated features and accessories and first device 14 then transmits the retrieved safety switch identifier number and the quotation to second device 14.

System 10 then prompts the user to order one or more of the selected products. If the user is a registered user, system 10 accepts orders online by providing the user a purchase order form and receiving the completed purchase order form from the user. The completed purchase order form is then authenticated against predetermined criteria to determine whether system 10 should accept the completed purchase order form. If the purchase order form is accepted, the ordered product is then shipped to the user.

If the user is an unregistered user, and the user attempts to order a selected product, system 10 transmits a notification to the user indicating that a sales person or an authorized distributor will contact the user to confirm the order request. System 10 then transmits a notification, such as via email, to a selected person. The selected person then checks the order and instructs system 10 to transmit the order to a field sales regional manager or district manager. The field sales manager then follows-up with the lead or forwards the lead to a distributor with instructions to follow-up with the user that submitted the order.

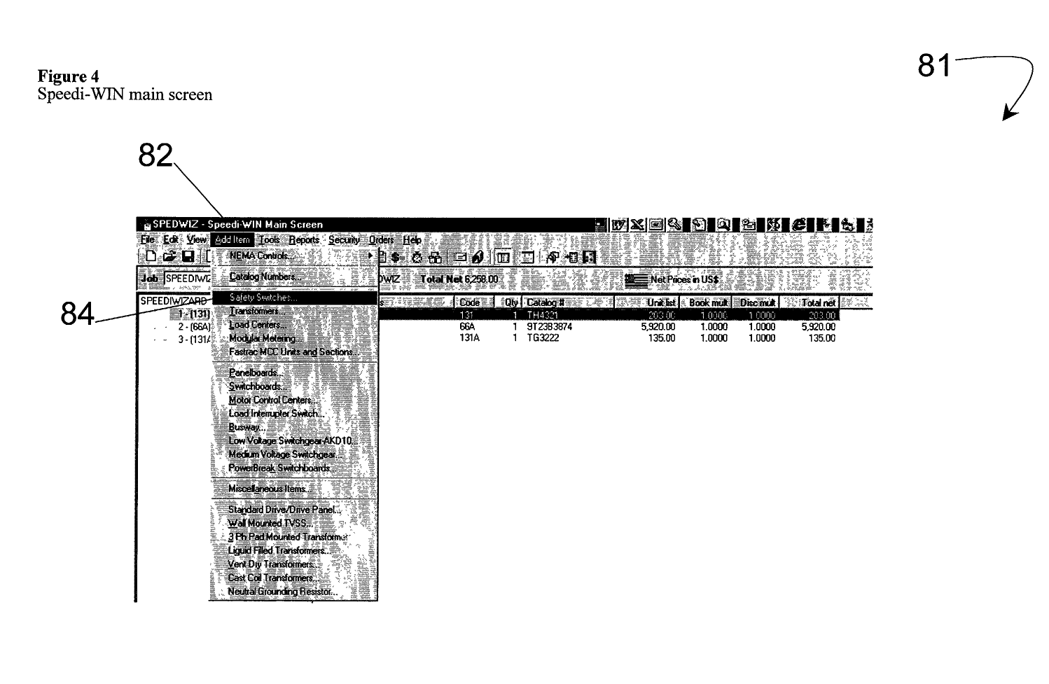

FIG. 4 shows an exemplary embodiment of a PC-based application for ordering products, in this case safety switches, as depicted in screen shot 81. Screen shot 81 includes a window 82 of a PC-based application having an Add Item toolbar entry, selection of which displays a pull down menu 84 that includes a Safety Switches selection.

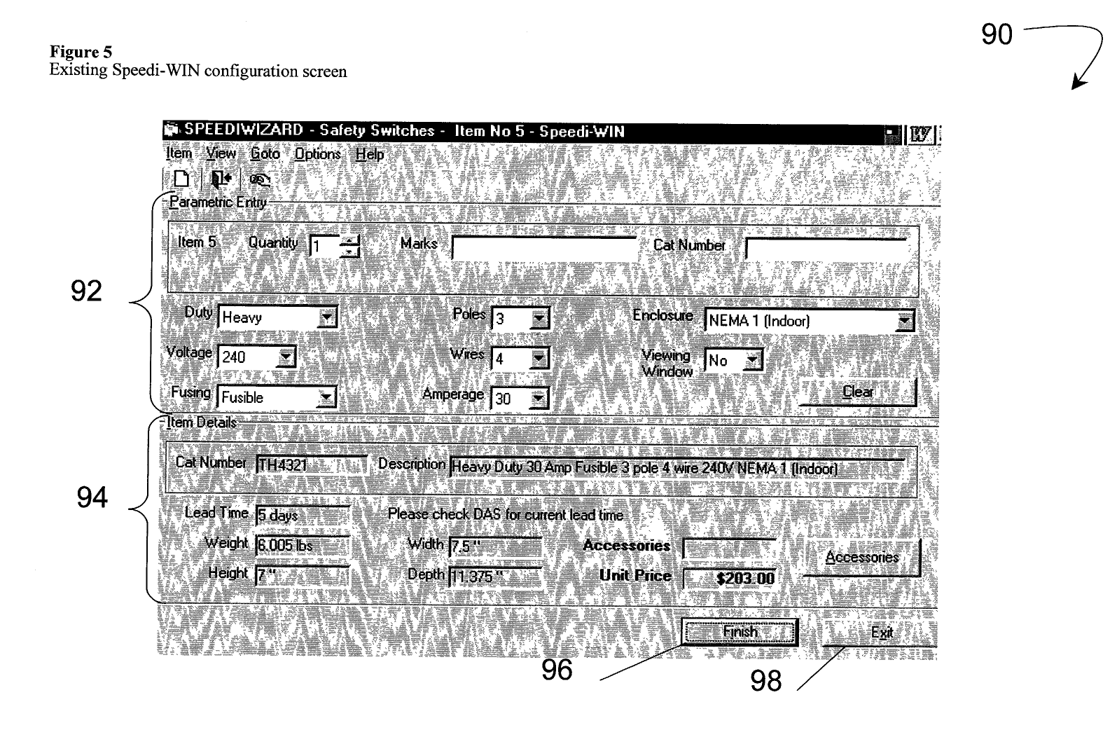

FIG. 5 shows an exemplary embodiment of a PC-based application for selecting and configuring products, in this case safety switches, as depicted in screen shot 90. Screen shot 90 includes a Parametric Entry data area 92, where a specification can be made of the quantity, the marks, the catalog number, the duty, the voltage, the fusing, the number of poles, the number of wires, the amperage, the enclosure type, and whether a viewing window is desired in a safety switch. Screen shot 90 also includes an Item Details display area 94 that includes text boxes that display the catalog number, description, lead time, weight, height, width, depth, accessories, and unit price of the selected product, as well as an Accessories radio button for selection of accessories for a safety switch. Screen shot 90 also includes a Finish radio button 96, and an Exit radio button 98.

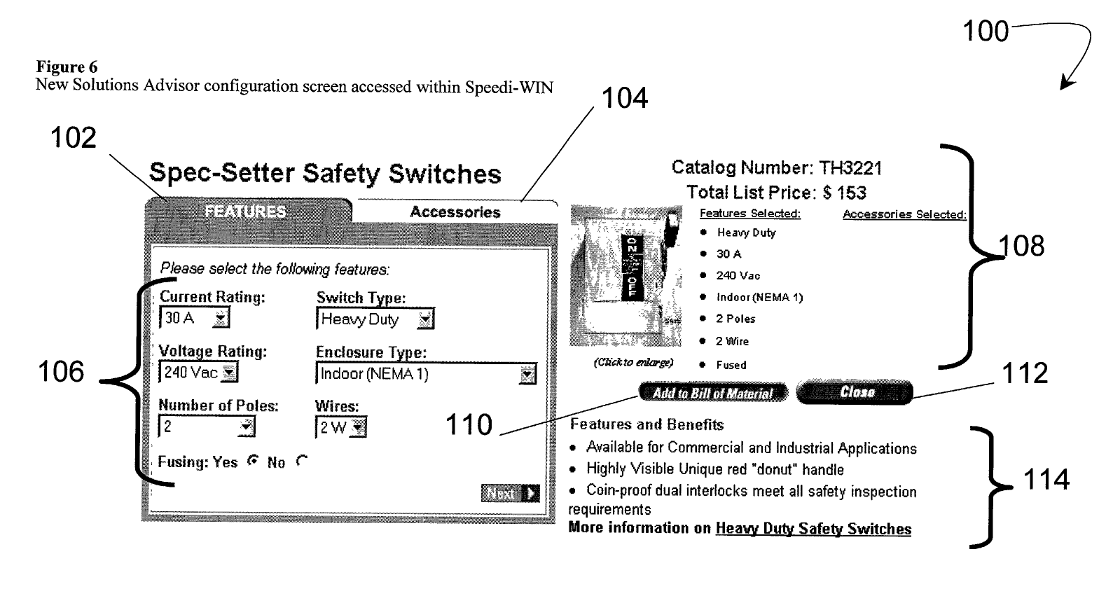

FIG. 6 shows an exemplary embodiment of a network-based tool page for product selection and configuration that is functionally connected with the PC-based application for selecting and ordering products, in this exemplary embodiment safety switches, as depicted in screen shot 100. Product specification information entered on the page shown in FIG. 4 is transmitted from the PC-based application to the network-based application to yield the page shown in screen shot 100. Screen shot 100 includes a Features tab 102, and an Accessories tab 104. Screen shot 100 results from selection of Features tab 102, and includes a product configuration area 106 with pull down menus for specifying a current rating, a voltage rating, the number of polls, the switch type, the enclosure type, and the number of wires, as well as a check box to indicate whether a fuse is desired. Screen shot 100 also includes a recommendation display area 108 that displays product specifications, including in one embodiment the catalog number and list price of the recommended product. Screen shot 100 further includes an Add to Bill of Material radio button 110, a Close radio button 112, and a Features and Benefits display area 114.

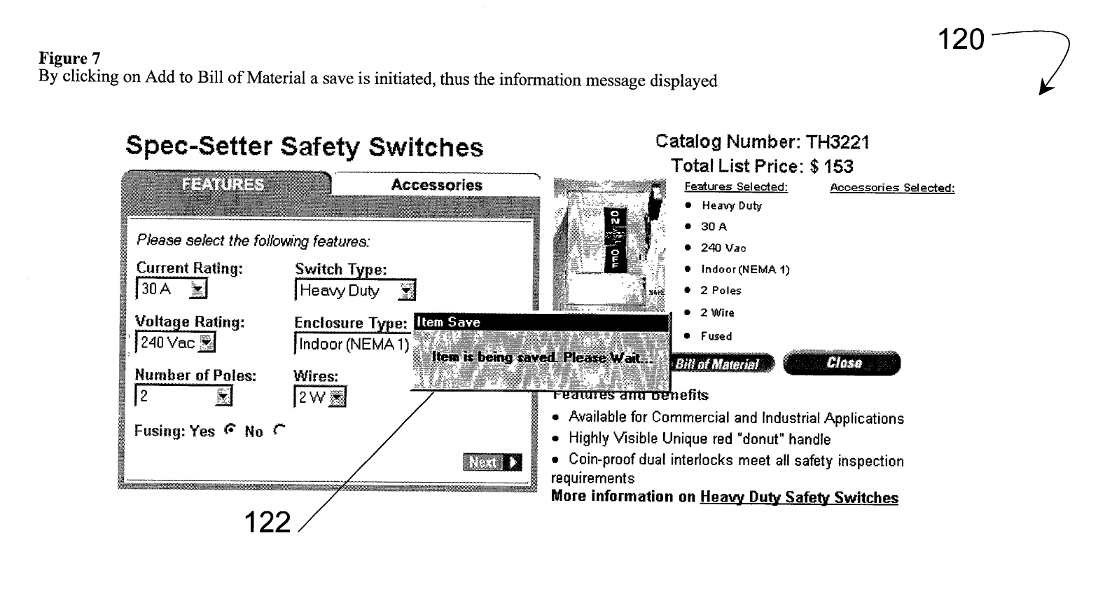

FIG. 7 shows an exemplary embodiment of a network-based page that may be running locally on a user's PC for selecting and configuring products, as depicted in screen shot 120. Selection by the user of Add to Bill of Material radio button 110 results in display of screen shot 120, that includes a message display box 122 informing the user that information relating to the selected item is being saved.

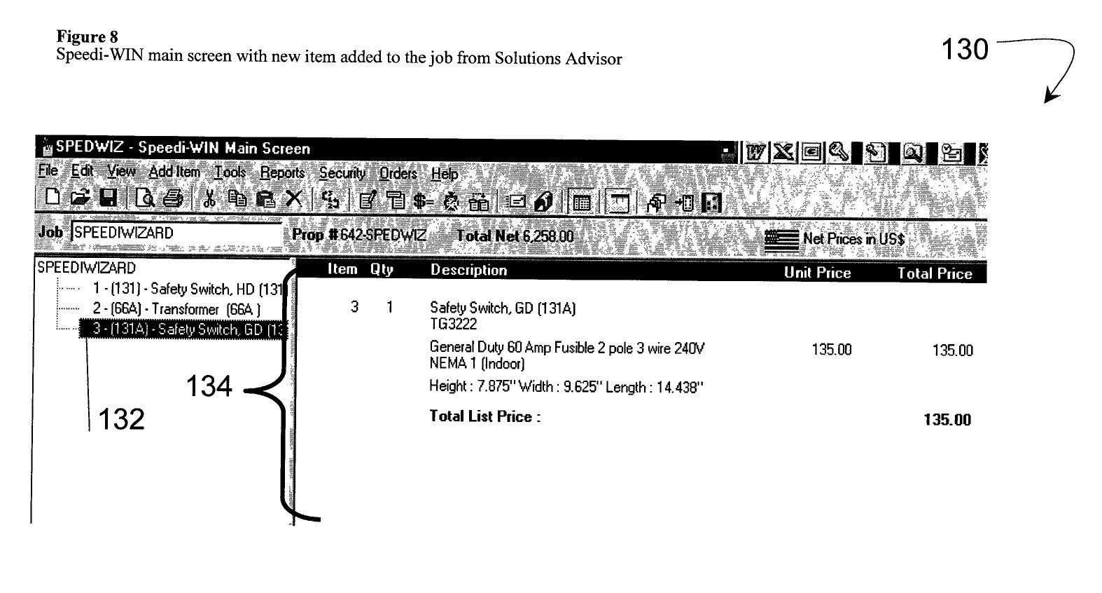

FIG. 8 shows an exemplary embodiment of a PC-based application window that results from saving from the network-based tool, which may be running locally on a user's PC to the PC-based application of the information relating to the item selected in FIG. 7, as depicted in screen shot 130. Screen shot 130 includes a product entry 132 that specifies a previously selected product. Screen shot 130 also includes a product specification information area 134 that displays information about the selected product or products, including in one embodiment the item number, the quantity, a description, a unit price, and the total price.

System 10 facilitates an easy and efficient method for integrating a PC-based applications with a network-based tool running locally on a user's PC for selecting and configuring products. While the invention has been described in terms of various specific embodiments, those skilled in the art will recognize that the invention can be practiced with modification within the spirit and scope of the claims.

What is claimed is:

1. A method for facilitating selection and configuration of a product through use of a computer-based application, a browser on a network-based system, and at least one device running the computer-based application, the device being connected to a network, said method comprising the steps of:
receiving product specification information from a user via the device running the computer-based application;
transferring the received information from the computer-based application to the network-based browser;
comparing the received product specification information with pre-stored product information;
selecting at least one product that matches the received product specification information; and
downloading information related to the product to the computer.

2. A method according to claim 1 wherein said network-based system runs on a server.

3. A method according to claim 1 wherein said network-based system runs on locally on a user's computer.

4. A method according to claim 1 wherein said step of receiving product specification information comprises the step of receiving product features information for the product.

5. A method according to claim 1 wherein the product comprises electrical equipment.

6. A method according to claim 5 wherein the product is an item of electrical equipment.

7. A method according to claim 6 wherein the product is selected from the group consisting of NEMA controls, safety switches, load centers, modular metering, panel boards, switch boards, motor control centers, load interrupter switches, busways, low voltage switchgear, power break switch boards, miscellaneous items, standard drive/drive panels, wall mounted transient voltage surge suppressors, three-phase pad mounted transformers, liquid filled transformers, vent dry transformers, cast coil transformers, and neutral grounding resistors.

8. A method according to claim 1 wherein said step of receiving product information data from a user further comprises the step of receiving an identification of accessories for the product.

9. A method according to claim 1 wherein said step of downloading information related to the product comprises the step of downloading the features selected for the product.

10. A method according to claim 1 wherein said step of downloading information related to the product comprises the step of downloading the accessories selected for the product.

11. A method according to claim 1 wherein said step of downloading information related to the product comprises the step of downloading the dimensions of the product.

12. A method according to claim 1 wherein said step of downloading information related to the product comprises the step of downloading a product catalog number and a list price for the product.

13. A method according to claim 1 wherein said step of downloading information further comprises the step of generating a quotation for the product.

14. A method according to claim 1 wherein the product specification information is received from the user via a graphical user interface.

15. A method according to claim 1 further comprising the step of assessing a need of the user based on at least one of a product application, product parameters, desired product features, and product accessories.

16. A method according to claim 15 further comprising the step of validating configuration compatibility based on the received product specification information to determine whether a resulting product incorporating a product having the received product specifications is capable of meeting parameters of the product.

17. A method according to claim 15 further comprising the step of guiding the user, if the resulting product does not meet the parameters of the product, to a correct product configuration.

18. A method according to claim 14 further comprising the step of guiding the user to a compatible product.

19. A system for facilitating selection of a product, said system comprising:
a device; and
a server based product configurator which may be running locally on a user's computer and configured to receive product information data from a user via said device, the product information including at least one of a feature of the product and an accessory of the product, said server further configured to identify stored product information data that matches the product information data entered by the user.

20. A system according to claim 19 wherein the device is a computer running a computer-based application.

21. A system according to claim 19 wherein said server further configured to select at least one product from the stored product information data that matches the product identification data entered by the user.

22. A system according to claim 19 wherein said server further configured to generate a quotation for each selected product.

23. A system according to claim 20 wherein said server further configured to download to the user information related to the selected product.

24. A system according to claim 19 wherein said server further configured to accept a purchase order for the product after the purchase order has been authenticated against pre-determined criteria.

25. A system according to claim 19 wherein said device configured to be a server for a network of customer devices.

26. A system according to claim 19 wherein said server and said device are connected via a network.

27. A system according to claim 26 wherein said network is one of a wide area network, a local area network and the Internet.
